(19) United States
(12) Patent Application Publication
(10) Pub. No.: US 2023/0080029 A1
(43) Pub. Date: Mar. 16, 2023

(54) SECONDARY BATTERY, PREPARATION METHOD THEREOF, AND APPARATUS CONTAINING SAME

(71) Applicant: Contemporary Amperex Technology Co., Limited, Ningde City (CN)

(72) Inventors: Bangrun Wang, Ningde City (CN); Xin Sun, Ningde City (CN)

(21) Appl. No.: 18/054,916

(22) Filed: Nov. 14, 2022

Related U.S. Application Data
(63) Continuation of application No. PCT/CN2020/091311, filed on May 20, 2020.

(51) Int. Cl. H01M 4/04; H01M 4/62; H01M 4/66; H01M 4/525

(52) U.S. Cl. CPC H01M 4/0404; H01M 4/625; H01M 4/661; H01M 4/525; H01M 2004/021

(57) ABSTRACT

A secondary battery is provided. In some embodiments, the secondary battery includes an electrode plate and a tab , and the electrode plate includes a current collector and an electrode plate film layer disposed on the current collector. The electrode plate film layer has a first zone and a second zone along an extension direction of the tab, where the second zone is closer to the tab than the first zone, a thickness of the first zone is denoted as H1, a thickness of the second zone is denoted as H2, and the electrode plate film layer satisfies 0.6≤H2/H1<1. In various embodiments, a preparation method of such secondary battery and an apparatus containing such secondary battery are provided.

### CROSS-REFERENCE TO RELATED APPLICATIONS

This disclosure is a continuation of International Application No. PCT/CN2020/091311, filed on May 20, 2020, which is hereby incorporated by reference in its entirety.

### TECHNICAL FIELD

This disclosure relates to a secondary battery and a preparation method thereof, and further relates to an apparatus containing such secondary battery.

### BACKGROUND

Secondary batteries have been widely used in various consumer electronic products and electric vehicles due to their prominent advantages of light weight, no pollution, and no memory effect.

With the development of the new energy industry, people propose higher requirements for use of secondary batteries. How secondary batteries can have both high energy density and good electrochemical performance is a key challenge in the field of secondary batteries.

In view of this, it is necessary to provide a secondary battery which delivers good performance in various aspects, so as to meet the use requirements of users.

### SUMMARY

In various embodiments, a secondary battery, a preparation method thereof, and an apparatus containing such secondary battery are provided, so that a secondary battery having high energy density also has good cycling performance.

To achieve the above objective, a first aspect of this disclosure provides a secondary battery. The secondary battery includes an electrode plate and a tab, and the electrode plate includes a current collector and an electrode plate film layer disposed on the current collector. The electrode plate film layer has a first zone and a second zone along an extension direction of the tab, where the second zone is closer to the tab than the first zone, a thickness of the first zone is denoted as H1, a thickness of the second zone is denoted as H2, and the secondary battery of this disclosure satisfies 0.6≤H2/H1<1.

A second aspect of this disclosure provides a preparation method of such secondary battery. The method includes the following steps: preparing an electrode plate such that the electrode plate film layer has a first zone and a second zone along an extension direction of the tab, where the second zone is closer to the tab than the first zone, a thickness of the first zone is denoted as H1, a thickness of the second zone is denoted as H2, and the electrode plate satisfies 0.6≤H2/H1<1.

A third aspect of this disclosure provides an apparatus. The apparatus includes the secondary battery in the first aspect of this disclosure or a secondary battery prepared by using the method provided in the second aspect of this disclosure.

Compared with the prior art, this disclosure includes at least the following beneficial effects:

In the secondary battery of this disclosure, the electrode plate film layer includes the first zone and the second zone, and the first zone and the second zone satisfies a specific relationship in terms of thickness, greatly reducing the interfacial resistance and polarization of the battery. Therefore, the secondary battery of this disclosure can have both high energy density and good cycling performance.

### BRIEF DESCRIPTION OF DRAWINGS

To describe the technical solutions of this disclosure more clearly, the following briefly describes the accompanying drawings used in this disclosure. Apparently, the accompanying drawings in the following description show merely some embodiments of this disclosure, and a person of ordinary skill in the art may still derive other drawings from these accompanying drawings without creative efforts.

FIG. 1 is a schematic diagram of an embodiment of a secondary battery according to this disclosure;

FIG. 2 is an exploded view of FIG. 1;

FIG. 3 is a schematic diagram of an embodiment of an electrode plate according to this disclosure;

FIG. 4 is a schematic diagram of another embodiment of an electrode plate according to this disclosure;

FIG. 5 is a schematic diagram of an embodiment of an electrode assembly according to this disclosure;

FIG. 6 is a schematic diagram of another embodiment of an electrode assembly according to this disclosure;

FIG. 7 is a schematic diagram of an embodiment of a battery module according to this disclosure;

FIG. 8 is a schematic diagram of an embodiment of a battery pack according to this disclosure;

FIG. 9 is an exploded view of the battery pack in FIG. 8; and

FIG. 10 is a schematic diagram of an embodiment of an apparatus according to this disclosure.

### DETAILED DESCRIPTION OF EMBODIMENTS

The following further describes this disclosure with reference to embodiments. It should be understood that these specific embodiments are merely intended to illustrate this disclosure but not to limit the scope of this disclosure.

For brevity, this specification specifically discloses only some numerical ranges. However, any lower limit may be combined with any upper limit to form a range not expressly recorded; any lower limit may be combined with any other lower limit to form a range not expressly recorded; and any upper limit may be combined with any other upper limit to form a range not expressly recorded. In addition, each separately disclosed point or individual value may itself be a lower limit or upper limit to be combined with any other point or individual value or combined with any other lower limit or upper limit to form a range not expressly recorded.

In the description of this specification, it should be noted that, unless otherwise stated, “more than” and “less than” are inclusive of the present number, and “more” in “one or more” means two or more than two.

Unless otherwise specified, terms used in this disclosure have well-known meanings generally understood by persons skilled in the art. Unless otherwise specified, numerical values of parameters mentioned in this disclosure may be measured by using various measurement methods commonly used in the art (for example, testing may be performed by using the methods provided in the examples of this disclosure).

### Secondary Battery

The secondary battery in accordance with this disclosure includes an electrode plate and a tab, and the electrode plate includes a current collector and an electrode plate film layer plate film layer disposed on the current collector. The electrode plate film layer has a first zone and a second zone along an extension direction of the tab, where the second zone is closer to the tab than the first zone, a thickness of the first zone is denoted as H1, a thickness of the second zone is denoted as H2, and the secondary battery of this disclosure satisfies 0.6≤H2/H1<1.

In the secondary battery in accordance with this disclosure, the electrode plate film layer includes different zones with a specific relationship in terms of thickness. Without wishing to be constrained by any theory, it is believed that such a structure allows a marginal space in the film layer to be reasonably designed, thereby enhancing electrolyte retention capacity of the film layer and improving infiltration of electrolyte into the film layer so as to increase the utilization efficiency of active materials and effectively improve long-term cycling performance of the battery. In addition, when thicknesses of various zones in the film layer conform to the above design, time that the electrolyte infiltrates to the inside of the film layer can be effectively shortened, so that the electrode plate is uniformly infiltrated by the electrolyte at an early stage of cycling, thereby effectively reducing resistance between the film layers, increasing the utilization efficiency of active materials, and effectively improving the overall performance of the battery.

In the secondary battery in accordance with this disclosure, the electrode plate may be a positive-electrode plate and/or a negative-electrode plate.

In some preferred embodiments, the electrode plate is a negative-electrode plate.

[Negative-Electrode Plate]

In the secondary battery in accordance with this disclosure, the negative-electrode plate includes a negative-electrode current collector and a negative-electrode film layer disposed on the negative-electrode current collector, where the negative-electrode film layer includes a negative-electrode active material.

In some preferred embodiments, the negative-electrode film layer includes a first zone and a second zone along an extension direction of the tab, where the second zone is closer to the tab than the first zone, a thickness of the first zone is denoted as H1, a thickness of the second zone is denoted as H2, and the negative-electrode film layer satisfies 0.6≤H2/H1<1.

In some embodiments, the negative-electrode film layer satisfies 0.7≤H2/H1≤0.8. When the secondary battery satisfies this range, energy density of the battery can be further improved.

In the secondary battery in accordance with this disclosure, if the negative-electrode film layer conforming to the above design also optionally satisfies one or more of the following parameters, performance of the battery can be further improved.

In some embodiments, the extension direction of the tab is defined as a width direction of the negative-electrode film layer, a width of the first zone is denoted as W1, a width of the second zone is denoted as W2, and the secondary battery further satisfies 0.03≤W2/W1≤0.1, preferably, 0.04≤W2/W1≤0.06. When the width of the first zone and that of the second zone satisfy the above condition, the infiltration performance of the electrolyte can be further improved while high energy density is ensured. This is conductive to reducing resistance between the film layers so as to improve the cycling stability of the battery.

In some embodiments, 0.04 mm≤H1≤0.15 mm, more preferably, 0.05 mm≤H1≤0.12 mm.

In some embodiments, 30 mm≤W1≤500 mm, more preferably, 60 mm≤W1≤200 mm.

The negative-electrode film layer satisfying the above condition can not only guarantee ease of processing of the negative-electrode plate but also ensure that the battery has enough active substances, thereby improving the energy density of the battery.

In the secondary battery in accordance with this disclosure, the negative-electrode current collector may be a conventional metal foil or a composite current collector (for example, a metal material may be provided on a polymer matrix to form a composite current collector). In an example, the negative-electrode current collector may be a copper foil.

In the secondary battery in accordance with this disclosure, the negative-electrode active material is not limited to any specific type, and any active materials that are known in the art and that can be used for negative electrodes of secondary batteries may be used, and persons skilled in the art can make selection according to actual demands.

In an example, the negative-electrode active material may include but is not limited to one or more of synthetic graphite, natural graphite, hard carbon, soft carbon, silicon-based materials and tin-based materials. The silicon-based material may be selected from one or more of elemental silicon, silicon-oxygen compounds (such as silicon monoxide), silicon-carbon compounds, silicon-nitrogen compounds, and silicon alloys. The tin-based material may be selected from one or more of elemental tin, tin-oxygen compounds, and tin alloys. These materials are all commercially available.

In some embodiments, to further improve the energy density of the battery, the negative-electrode active material includes a silicon-based material.

In some embodiments, the silicon-based material includes a silicon-oxygen compound (for example, SiOx, 0<x<2).

In some embodiments, a mass percentage of the silicon-based material in the negative-electrode active material is ≤50%, preferably, 15%-30%. When the amount of the silicon-based material is within the given range, the battery can have both high energy density and good cycling performance.

In some embodiments, a press density PD of the negative-electrode film layer is 1.5 g/cm³≤PD≤1.8 g/cm³, preferably, 1.6 g/cm³≤PD≤1.7 g/cm³. An excessively low PD is likely to cause fall of coating from the second zone, deteriorating cycling performance of the battery. In addition, such PD also causes reduction in volumetric energy density of the battery. An excessively high PD is not conductive to de-intercalation of active ions, increasing polarization of the battery which in turn decreases capacity of the battery. In addition, such PD also greatly impacts the infiltration of electrolyte into the first zone, affecting cycling performance of the battery.

In the secondary battery in accordance with this disclosure, the negative-electrode film layer optionally includes a binder, a conductive agent, and other optional additives.

In an example, the conductive agent is one or more of superconducting carbon, acetylene black, carbon black, Ketjen black, carbon dot, carbon nanotube, graphene, and carbon nanofiber.

In an example, the binder is one or more of styrene-butadiene rubber (SBR), water-based acrylic resin (water-based acrylic resin), polyvinylidene fluoride (PVDF), polytetrafluoroethylene (PTFE), ethylene vinyl acetate (EVA), polyvinyl alcohol (PVA), and polyvinyl butyral (PVB).

In an example, the other optional additives may be thickening and dispersing agents (such as sodium carboxymethyl cellulose CMC-Na), PTC thermistor materials, and the like.

It can be understood that the negative-electrode current collector includes two back-to-back surfaces in a thickness direction thereof, and the negative-electrode film layer is provided on either or both of the two back-to-back surfaces of the negative-electrode current collector.

It should be noted that the negative-electrode film layer parameters in this disclosure all refer to parameter ranges of a film layer on one side. When the negative-electrode film layer is provided on both surfaces of the negative-electrode current collector, the parameters of the film layer on either of the two surfaces being compliant with this disclosure are considered to fall within the protection scope of this disclosure. In addition, thickness, width, press density, and the like of the negative-electrode film layer in this disclosure are all parameters of a film layer cold-pressed for assembling a battery.

[Positive-Electrode Plate]

In the secondary battery of this disclosure, the positive-electrode plate includes a positive-electrode current collector and a positive-electrode film layer disposed on the positive-electrode current collector, where the positive-electrode film layer includes a positive-electrode active material.

In some embodiments, the positive-electrode film layer includes a first zone and a second zone along an extension direction of the tab, where the second zone is closer to the tab than the first zone, a thickness of the first zone is denoted as H1, a thickness of the second zone is denoted as H2, and the positive-electrode film layer satisfies 0.6≤H2/H1<1.

When the positive-electrode film layer of this disclosure conforms to the above design, for other design parameters of the first zone and second zone, reference may be made to the parameter ranges of the negative-electrode plate, without more details given herein.

In the secondary battery of this disclosure, the positive-electrode current collector may be a conventional metal foil or a composite current collector (a metal material may be provided on a polymer matrix to form a composite current collector). In an example, the positive-electrode current collector may be an aluminum foil.

In the secondary battery of this disclosure, the positive-electrode active material is not limited to any specific type, and any active materials that are known in the art and that can be used for positive electrodes of secondary batteries may be used, and persons skilled in the art can make selection according to actual demands.

In an example, the positive-electrode active material may include but is not limited to one or more of lithium transition metal composite oxides, lithium-containing phosphates with an olivine structure, and their respective modified compounds. The lithium transition metal composite oxide may include but is not limited to one or more of lithium cobalt oxides, lithium nickel oxides, lithium manganese oxides, lithium nickel cobalt oxides, lithium manganese cobalt oxides, lithium manganese nickel oxides, lithium nickel manganese cobalt oxides, lithium nickel aluminum cobalt oxides, and modified compounds thereof. The lithium-containing phosphates with an olivine structure may include but are not limited to one or more of lithium iron phosphate, composite materials of lithium iron phosphate and carbon, lithium manganese phosphate, composite materials of lithium manganese phosphate and carbon, lithium ferric manganese phosphate, composite materials of lithium ferric manganese phosphate and carbon, and modified compounds thereof. These materials are all commercially available.

In some embodiments, to further improve the energy density of the battery, the positive-electrode active material may include one or more of lithium transition metal composite oxides shown in formula 1 and modified compounds thereof:

LiₐNi_{b}Co_{c}M_{d}OₑA_{f} formula 1

in formula 1, 0.8≤a≤1.2, 0.5≤b<1, 0<c<1, 0<d<1, 1≤e≤2, 0≤f≤1, M is selected from one or more of Mn, Al, Zr, Zn, Cu, Cr, Mg, Fe, V, Ti and B, and A is selected from one or more of N, F, S, and Cl.

In this disclosure, the modified compounds of the materials may be obtained through doping modification and/or surface coating modification to the materials.

In the secondary battery of this disclosure, the positive-electrode film layer optionally includes a binder, a conductive agent, and other optional additives.

In an example, the conductive agent is one or more of superconducting carbon, acetylene black, carbon black, Ketjen black, carbon dot, carbon nanotube, Super P (SP), graphene, and carbon nanofiber.

In an example, the binder is one or more of styrene-butadiene rubber (SBR), water-based acrylic resin (water-based acrylic resin), polyvinylidene fluoride (PVDF), polytetrafluoroethylene (PTFE), ethylene vinyl acetate (EVA), polyacrylic acid (PAA), carboxymethyl cellulose (CMC), polyvinyl alcohol (PVA), and polyvinyl butyral (PVB).

It can be understood that the positive-electrode current collector includes two back-to-back surfaces in a thickness direction thereof, and the positive-electrode film layer is provided on either or both of the two back-to-back surfaces of the positive-electrode current collector.

It should be noted that the positive-electrode film layer parameters in this disclosure all refer to parameter ranges of a film layer on one side. When the positive-electrode film layer is provided on both surfaces of the positive-electrode current collector, the parameters of the film layer on either of the two surfaces being compliant with this disclosure are considered to fall within the protection scope of this disclosure. In addition, thickness, width, and the like of the positive-electrode film layer in this disclosure are all parameters of a film layer cold-pressed for assembling a battery.

[Electrolyte]

The secondary battery of this disclosure further includes an electrolyte, and the electrolyte provides ion conduction between the positive-electrode plate and the negative-electrode plate. The electrolyte may include an electrolytic salt and a solvent.

In an example, the electrolytic salt may be selected from one or more of LiPF₆ (lithium hexafluorophosphate), LiBF₄ (lithium tetrafluoroborate), LiClO₄ (lithium perchlorate), LiAsF₆ (lithium hexafluoroborate), LiFSI (lithium bis(fluorosulfonyl)bisfluorosulfonyl imide), LiTFSI (lithium bis-trifluoromethanesulfonimide), LiTFS (lithium trifluoromethanesulfonat), LiDFOB (lithium difluorooxalatoborate), LiBOB (lithium bisoxalatoborate), LiPO₂F₂ (lithium difluorophosphate), LiDFOP (lithium difluoro (oxalate) borate), and LiTFOP (lithium tetrafluoro oxalate phosphate).

In an example, the solvent may be selected from one or more of ethylene carbonate (EC), propylene carbonate (PC), ethyl methyl carbonate (EMC), diethyl carbonate (DEC), dimethyl carbonate (DMC), dipropyl carbonate (DPC), methyl propyl carbonate (MPC), ethyl propyl carbonate (EPC), butylene carbonate (BC), fluoroethylene carbonate (FEC), methyl formate (MF), methyl acetate (MA), ethyl acetate (EA), propyl acetate (PA), methyl propionate (MP), ethyl propionate (EP), propyl propionate (PP), methyl butyrate (MB), ethyl butyrate (EB), 1,4-butyrolactone (GBL), tetramethylene sulfone (SF), methylsulfonylmethane (MSM), ethyl methyl sulfone (EMS), and diethyl sulfone (ESE).

In some embodiments, the electrolyte further includes an additive. For example, the additive may include a negative-electrode film forming additive, or may include a positive-electrode film forming additive, or may include an additive capable of improving some performance of a battery, for example, an additive for improving over-charge performance of the battery, an additive for improving high-temperature performance of batteries, and an additive for improving low-temperature performance of the battery.

[Separator]

The secondary battery of this disclosure further includes a separator, and the separator is arranged between the positive-electrode plate and the negative-electrode plate to provide a separation function. This disclosure does not impose any special limitations on the separator, and any commonly known porous separator with good chemical stability and mechanical stability may be used.

In an example, the separator may be selected from one or more of glass fiber, non-woven fabrics, polyethylene, polypropylene, and polyvinylidene fluoride. The separator may be a single-layer thin film or a multi-layer composite thin film. When the separator is a multi-layer composite thin film, the multiple layers may be made of the same or different materials.

All materials used in this disclosure are commercially available.

In this disclosure, thickness of an electrode plate film layer has the meaning well-known in the art, and can be tested by known methods in the art. For example, the thickness may be measured by a ten-thousandths micrometer (of model Mitutoyo293-100 with 0.1 μm resolution).

In this disclosure, width of an electrode plate film layer has the meaning well-known in the art, and can be tested by known methods in the art. For example, the width may be measured by a straight rule.

In this disclosure, press density of the electrode plate film layer has the meaning well-known in the art, and can be tested by known methods in the art. For example, a single-side-coated and cold-pressed electrode plate (in the case of an electrode plate having coating on both sides, a film layer on one side thereof may be wiped off firstly) is punched into a small wafer with an area of S1; the wafer is weighed and its weight is recorded as M1, and the thickness of the electrode plate film layer is measured by the above method and recorded as T. Then, the film layer of the weighed electrode plate is wiped off, and the negative-electrode current collector is weighed and recorded as M0. Press density PD of electrode plate film layer=(M1−M0)/(S1×T).

In some embodiments, the secondary battery of this disclosure is a lithium-ion secondary battery.

In some embodiments, the above positive electrode plate, negative electrode plate, and separator may be made into an electrode assembly through winding or lamination.

In some embodiments, the secondary battery may include an outer package. The outer package may be used for packaging the electrode assembly and the electrolyte.

In some embodiments, the outer package of the secondary battery may be a hard shell, for example, a hard plastic shell, an aluminum shell, or a steel shell. The outer package of the secondary battery may alternatively be a soft pack, for example, a soft pouch. A material of the soft pack may be plastic, for example, one or more of polypropylene (PP), polybutylene terephthalate (PBT), polybutylene succinate (PBS), and the like.

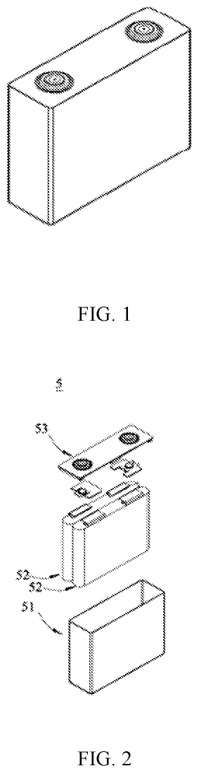

This disclosure does not impose special limitations on the shape of the secondary battery, and the battery may be cylindrical, rectangular, or of any other shapes. FIG. 1 shows a secondary battery of a rectangular structure as an example.

In some embodiments, referring to FIG. 2, the outer package may include a housing 51 and a cover plate 53. The housing 51 may include a base plate and side plates connected to the base plate, and the base plate and the side plates enclose an accommodating cavity. The housing 51 has an opening communicating with the accommodating cavity, and the cover plate 53 covers the opening to close the accommodating cavity. A positive-electrode plate, a negative-electrode plate, and a separator may be wound or stacked to form an electrode assembly 52. The electrode assembly 52 is packaged in the accommodating cavity. The electrolyte is infiltrated into the electrode assembly 52. There may be one or more electrode assemblies 52 in the secondary battery 5, and the quantity may be adjusted as required.

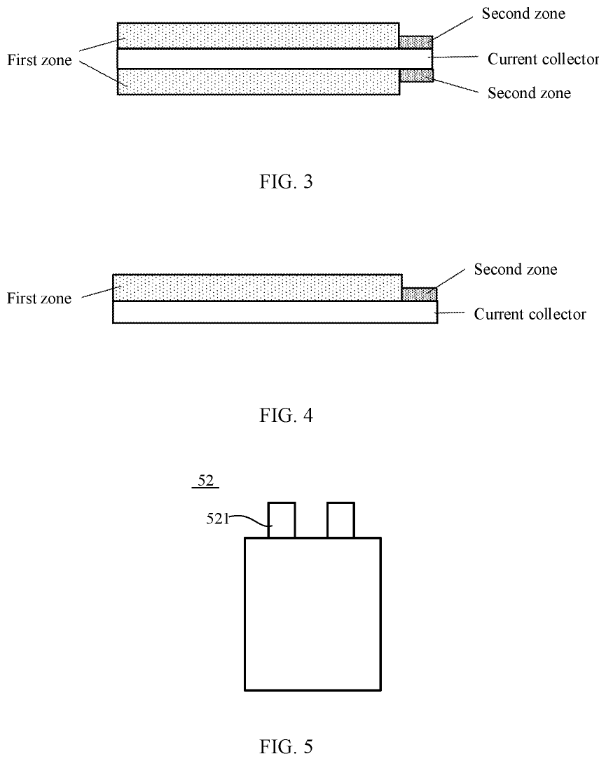

FIG. 3 is a schematic diagram of an electrode plate with an electrode plate film layer on both surfaces of a current collector, and FIG. 4 is a schematic diagram of an electrode plate with an electrode plate film layer on only one surface of a current collector.

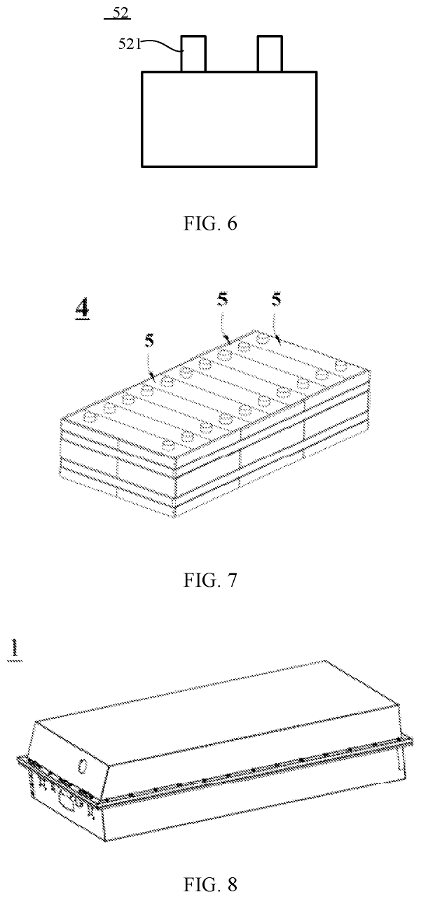

In the secondary battery of this disclosure, referring to schematic diagrams shown in FIG. 5 and FIG. 6, the electrode assembly 52 further includes two extending tabs 521 (namely, a positive-electrode tab and a negative-electrode tab), and the two extending tabs 521 extend out from a same side of the electrode assembly. Generally, the positive-electrode active material is applied onto a coating zone of the positive-electrode plate, and the positive-electrode tab is formed by stacking a plurality of uncoated zones extending from the coating zone of the positive-electrode plate; the negative-electrode active material is applied onto a coating zone of the negative-electrode plate, and the negative-electrode tab is formed by stacking a plurality of uncoated zones extending from the coating zone of the negative-electrode plate. The positive-electrode/negative-electrode tab may be obtained by punching or laser die cutting. Furthermore, the two tabs may be electrically connected to corresponding electrodes (which may be disposed onto a top cover of an outer package of the battery) via respective adapting sheets, so as to lead out electric energy.

In some embodiments, secondary batteries may be assembled into a battery module. The battery module may include a plurality of secondary batteries whose quantity may be adjusted according to the use case and capacity of the battery module.

FIG. 7 shows a battery module 4 used as an example. Referring to FIG. 7, in the battery module 4, a plurality of secondary batteries 5 may be sequentially arranged in a length direction of the battery module 4. Certainly, the secondary batteries may alternatively be arranged in any other manner. Further, the plurality of secondary batteries 5 may be fastened by using fasteners.

In some embodiments, the battery module 4 may further include a housing with an accommodating space, and the plurality of secondary batteries 5 are accommodated in the accommodating space.

In some embodiments, the battery module may be further assembled into a battery pack, and a quantity of battery modules included in the battery pack may be adjusted according to the use case and capacity of the battery pack.

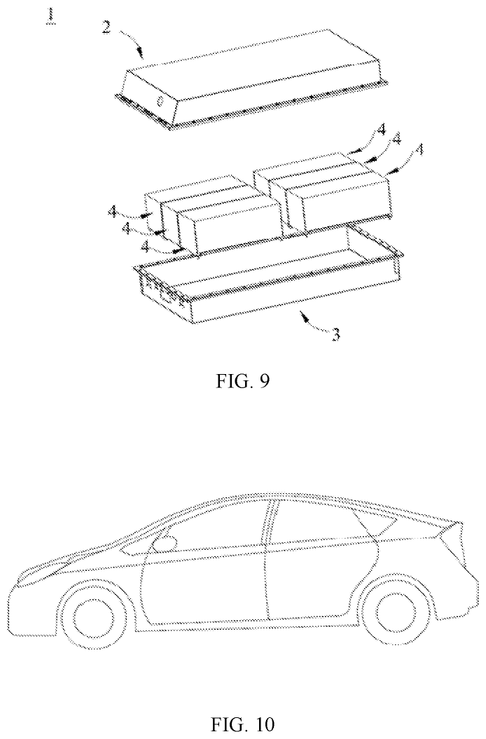

FIG. 8 and FIG. 9 show a battery pack 1 as an example. Referring to FIG. 8 and FIG. 9, the battery pack 1 may include a battery box and a plurality of battery modules 4 arranged in the battery box. The battery box includes an upper box body 2 and a lower box body 3. The upper box body 2 covers the lower box body 3 to form an enclosed space for accommodating the battery modules 4. The plurality of battery modules 4 may be arranged in the battery box in any manner.

### Preparation Method of Secondary Battery

A second aspect of this disclosure provides a preparation method of such secondary battery. The method includes the following steps: preparing an electrode plate (a positive-electrode plate and/or a negative-electrode plate) such that an electrode plate film layer has a first zone and a second zone along an extension direction of a tab, where the second zone is closer to the tab than the first zone, a thickness of the first zone is denoted as H1, a thickness of the second zone is denoted as H2, and the electrode plate satisfies 0.6≤H2/H1<1. The electrode plate film layer is obtained by using methods known to persons skilled in the art, for example, gaskets of different specifications may be used in a coating process.

Except for the preparation method of the electrode plate in this disclosure, other constructing and preparation methods of the secondary battery of this disclosure are commonly known. For example, the positive-electrode plate, the separator, and the negative-electrode plate are sequentially stacked so that the separator is located between the positive-electrode plate and the negative-electrode plate to provide separation. Then, the resulting stacks are wound (or laminated) to form the electrode assembly; the electrode assembly is placed into the outer package which is filled with electrolyte after drying, followed by processes including vacuum packaging, standing, formation, and shaping, to obtain the secondary battery.

### Apparatus

A third aspect of this disclosure provides an apparatus. The apparatus includes the secondary battery in the first aspect of this disclosure or a secondary battery prepared by using the method according to the second aspect of this disclosure. The secondary battery may be used as a power source of the apparatus or an energy storage unit of the apparatus. The apparatus in this disclosure uses the secondary battery provided by this disclosure, and therefore has at least the same advantages as the secondary battery.

The apparatus may be, but is not limited to, a mobile device (for example, a mobile phone or a notebook computer), an electric vehicle (for example, a battery electric vehicle, a hybrid electric vehicle, a plug-in hybrid electric vehicle, an electric bicycle, an electric scooter, an electric golf vehicle, or an electric truck), an electric train, a ship, a satellite, an energy storage system, and the like.

A secondary battery, a battery module, or a battery pack may be selected for the apparatus according to requirements for using the apparatus.

FIG. 10 shows an apparatus as an example. The apparatus is a battery electric vehicle, a hybrid electric vehicle, a plug-in hybrid electric vehicle, or the like. To meet requirements of the apparatus for high power and high energy density of the secondary batteries, a battery pack or a battery module may be used.

In another example, the apparatus may be a mobile phone, a tablet computer, a notebook computer, or the like. Such apparatus is usually required to be light and thin, and may use a secondary battery as its power source.

The following further describes beneficial effects of this disclosure with reference to examples.

### EXAMPLES

To make the technical problems, technical solutions, and beneficial effects of this disclosure clearer, the following further describes this disclosure in detail with reference to the examples and the accompanying drawings. Apparently, the described examples are merely some but not all of the examples of this disclosure. The following description of at least one illustrative example is merely illustrative and definitely is not construed as any limitation on this disclosure or on use of this disclosure. All other examples obtained by a person of ordinary skill in the art based on the examples of this disclosure without creative efforts shall fall within the protection scope of this disclosure.

### I. Preparation Method of Secondary Battery

### Example 1

### 1. Preparation of Positive-Electrode Plate

A positive-electrode active material LiNi_{0.8}Co_{0.1}Mn_{0.1}O₂ (NCM811), a conductive agent carbon black (Super P), and a binder polyvinylidene fluoride (PVDF) were uniformly mixed in a mass ratio of 96:3:1 in a proper amount of solvent N-methylpyrrolidone (NMP), to obtain a positive-electrode slurry. The positive-electrode slurry was applied on a positive-electrode current collector aluminum foil, followed by processes including drying, cold pressing, slitting, and cutting, to obtain a positive-electrode plate.

### 2. Preparation of Negative-Electrode Plate

Negative-electrode active material silicon monoxide and synthetic graphite were uniformly mixed at a mass ratio of 20:80, and then were uniformly mixed with a conductive agent carbon black (Super P), a binder styrene-butadiene rubber (SBR), and sodium carboxymethyl cellulose (CMC-Na) in a mass ratio of 96:1.5:1.5:1.0 in a proper amount of solvent deionized water, to obtain a negative-electrode slurry. The negative-electrode slurry was applied on a negative-electrode current collector copper foil, followed by processes including drying, cold pressing, slitting, and cutting, to obtain a negative-electrode plate. A first zone and a second zone were formed on the negative-electrode slurry during coating, where a thickness H1 of the first zone was 0.06 mm, a thickness H2 of the second zone was 0.036 mm, and a press density of a negative-electrode film layer was 1.65 g/cm³.

### 3. Separator

The separator was a polyethylene (PE) film.

### 4. Preparation of Electrolyte

Ethylene carbonate (EC) and ethyl methyl carbonate (EMC) were mixed in a mass ratio of 30:70, to obtain an organic solvent; a fully dried electrolytic salt LiPF₆ was dissolved in the above mixed solvent, with a concentration of 1.3 mol/L. Then, 6% fluoroethylene carbonate (FEC) as an additive was added into the mixed solvent, and uniformly mixed with the solvent, to obtain an electrolyte. A concentration of the electrolytic salt was calculated based on the total volume of the electrolyte, and the additive content is a weight percentage calculated based on the total weight of the electrolyte.

### 5. Preparation of Secondary Battery

The positive-electrode plate, the separator, and the negative-electrode plate were sequentially stacked, so that the separator was located between the positive-electrode plate and the negative-electrode plate to provide separation. Then, the resulting stacks were wound to form an electrode assembly. The electrode assembly was placed in the outer package and dried, and the prepared electrolyte was injected, followed by processes including vacuum packaging, standing, formation, and shaping, to obtain a secondary battery.

Secondary batteries in Examples 2 to 11 and Comparative Examples 1 to 2 were prepared in the same method as the secondary battery in Example 1 only with technical parameters for the preparation of the negative-electrode plate changed. Table 1 gives details about these different product parameters.

### II. Performance Test Method

### 1. Battery Resistance Test

At 25° C., the secondary batteries prepared in the Examples and Comparative Examples were charged to a charge cutoff voltage of 4.25 V at a constant current charge rate of 0.2 C, then charged at a constant voltage until current was ≤0.05 C, left for 5 minutes, then discharged to a discharge depth of 10% at a constant current discharge rate of 0.2 C, left for 5 minutes, and finally discharged to a discharge depth of 20% at a rate of 2 C (I_{d}). Voltage after and voltage before the 2 C discharge were respectively recorded as U₁ and U₂, and therefore discharge resistance is R_{d}=(U₁−U₂)/I_{d}.

### 2. Cycling Performance Test

At 25° C., the secondary batteries prepared in the Examples and Comparative Examples were charged to a charge cutoff voltage of 4.25 V at a constant current charge rate of 0.5 C, then charged at a constant voltage until current was ≤0.05 C, left for 5 minutes, then discharged to a discharge cutoff voltage of 2.5 V at a constant current discharge rate of 1 C, and left for 5 minutes. This was one charge and discharge cycle. The batteries were subjected to charge and discharge cycling until capacity of the batteries was declined to 80%. The number of cycles at that point was the cycling performance of the batteries at 25° C.

TABLE 1

| | Thickness | Width | Thickness | Width | | | | Cycling |
|---|---|---|---|---|---|---|---|---|
| | of first | of first | of second | of second | | | | performance |
| | zone H1 | zone W1 | zone H2 | zone W2 | | | Resistance | (cycles cls |
| Number | (mm) | (mm) | (mm) | (mm) | H2/H1 | W2/W1 | (mΩ) | to 80% SOH) |
| Example 1 | 0.06 | 84 | 0.036 | 4.2 | 0.60 | 0.05 | 1.08 | 832 |
| Example 2 | 0.06 | 84 | 0.042 | 4.2 | 0.70 | 0.05 | 0.93 | 858 |
| Example 3 | 0.06 | 84 | 0.045 | 4.2 | 0.75 | 0.05 | 0.82 | 876 |
| Example 4 | 0.06 | 84 | 0.048 | 4.2 | 0.80 | 0.05 | 0.95 | 855 |
| Example 5 | 0.06 | 84 | 0.054 | 4.2 | 0.90 | 0.05 | 1.09 | 829 |
| Example 6 | 0.06 | 84 | 0.045 | 1.680 | 0.75 | 0.02 | 1.13 | 814 |
| Example 7 | 0.06 | 84 | 0.045 | 2.520 | 0.75 | 0.03 | 1.02 | 841 |
| Example 8 | 0.06 | 84 | 0.045 | 3.360 | 0.75 | 0.04 | 0.96 | 852 |
| Example 9 | 0.06 | 84 | 0.045 | 5.040 | 0.75 | 0.06 | 0.98 | 854 |
| Example 10 | 0.06 | 84 | 0.045 | 6.720 | 0.75 | 0.08 | 1.07 | 835 |
| Example 11 | 0.06 | 84 | 0.045 | 9.240 | 0.75 | 0.11 | 1.15 | 811 |
| Comparative | 0.06 | 84 | 0.030 | 4.2 | 0.50 | 0.05 | 1.21 | 793 |
| Example 1 | | | | | | | | |
| Comparative | 0.06 | 84 | 0.060 | 0.0 | 1.00 | 0.00 | 1.35 | 783 |
| Example 2 | | | | | | | | |
| (not thinned) | | | | | | | | |

According to the above comparison between the Examples 1 to 5 and the Comparative Examples 1 to 2, when the electrode plate (negative-electrode plate) of this disclosure satisfies 0.6≤H2/H1<1, infiltration of electrolyte into the electrode plate is effectively improved and interfacial resistance of the batteries is reduced, thereby greatly improving cycling performance of the batteries.

According to the above Examples 3 and 6 to 11, when the electrode plate (negative-electrode plate) of this disclosure satisfies 0.03≤W2/W1≤0.1, especially when it satisfies 0.04≤W2/W1≤0.06, the cycling performance of the batteries can be further improved.

The foregoing descriptions are merely specific embodiments of this disclosure, but are not intended to limit the protection scope of this disclosure. Any equivalent modifications or replacements readily figured out by a person skilled in the art within the technical scope disclosed in this disclosure shall fall within the protection scope of this disclosure. Therefore, the scope of protection of this disclosure shall be subject to the scope of protection of the claims.

1. A secondary battery, comprising an electrode plate and a tab, wherein the electrode plate comprises a current collector and an electrode plate film layer disposed on the current collector, and the electrode plate film layer has a first zone and a second zone along an extension direction of the tab, wherein the second zone is closer to the tab than the first zone, a thickness of the first zone is denoted as H1, a thickness of the second zone is denoted as H2, and the electrode plate film layer satisfies 0.6≤H2/H1<1, preferably, 0.7≤H2/H1≤0.8.

2. The secondary battery according to claim 1, wherein the extension direction of the tab is defined as a width direction of the electrode plate film layer, a width of the first zone is denoted as W1, a width of the second zone is denoted as W2, and the secondary battery further satisfies 0.03≤W2/W1≤0.

3. The secondary battery according to claim 1, wherein 0.04 mm≤H1≤0.15 mm.

4. The secondary battery according to claim 1, wherein 30 mm≤W1≤500 mm, preferably, 60 mm≤W1≤200 mm.

5. The secondary battery according to claim 1, wherein the electrode plate is a negative-electrode plate, and the negative-electrode plate comprises a negative-electrode current collector and a negative-electrode film layer disposed on the negative-electrode current collector.

6. The secondary battery according to claim 5, wherein the negative-electrode film layer comprises a negative-electrode active material, and the negative-electrode active material comprises a silicon-based material; preferably, the silicon-based material comprises a silicon-oxygen compound.

7. The secondary battery according to claim 6, wherein the mass percentage of the silicon-based material in the negative-electrode active material is ≤50%, preferably, 15%-30%.

8. The secondary battery according to claim 5, wherein a press density PD of the negative-electrode film layer is 1.5 g/cm³≤PD≤1.8 g/cm³, preferably, 1.6 g/cm³ ≤PD≤1.7 g/cm³.

9. The secondary battery according to claim 1, wherein the secondary battery comprises a positive-electrode plate, wherein the positive-electrode plate comprises a positive-electrode current collector and a positive-electrode film layer disposed on the positive-electrode current collector, the positive-electrode film layer comprises a positive-electrode active material, and the positive-electrode active material comprises a lithium transition metal composite oxide;
preferably, the positive-electrode active material comprises one or more of lithium transition metal composite oxides shown in formula 1 and modified compounds thereof;
LiₐNi_{b}Co_{c}M_{d}OₑA_{f} formula 1
in formula 1, 0.8≤a≤1.2, 0.5≤b<1, 0<c<1, 0<d<1, 1≤e≤2, 0≤f≤1, M is selected from one or more of Mn, Al, Zr, Zn, Cu, Cr, Mg, Fe, V, Ti and B, and A is selected from one or more of N, F, S, and Cl.

10. A preparation method of secondary battery, comprising the following steps:
preparing an electrode plate such that the electrode plate film layer has a first zone and a second zone along an extension direction of a tab, wherein the second zone is closer to the tab than the first zone, a thickness of the first zone is denoted as H1, a thickness of the second zone is denoted as H2, and the electrode plate satisfies 0.6≤H2/H1<1.

11. An apparatus, comprising the secondary battery according to claim 1 or a secondary battery prepared by using the method according to claim 10.
